(19) United States
(12) Patent Application Publication
(10) Pub. No.: US 2002/0198292 A1
(43) Pub. Date: Dec. 26, 2002

(54) Use of etherified vinyl alcohol polymers as thickeners

(75) Inventors: Bernd Kayser, Neubiberg (DE); Werner Bauer, Winhoering (DE); Ulf Dietrich, Altoetting (DE); Andreas Bacher, Burghausen (DE); Marion Schmitz, Burghausen (DE); Harald Zeh, Burghausen (DE); Theo Mayer, Julbach (DE)

Correspondence Address: William G. Conger, Brooks & Kushman P.C., 22nd Floor, 1000 Town Center, Southfield, MI, 48075-1351, US

(73) Assignee: Wacker-Chemie GmbH, Munich (DE)

(21) Appl. No.: 10/124,976

(22) Filed: Apr. 18, 2002

(30) Foreign Application Priority Data
Apr. 26, 2001 (DE) 101 20 492.2

(51) Int. Cl. C08K 3/00

(52) U.S. Cl. 524/2; 524/9; 524/40

(57) ABSTRACT

Etherified vinyl alcohol polymers based on partially or completely hydrolyzed vinyl acetate homopolymers or copolymers, containing from 0.1 to 100 mol % of whose vinyl alcohol groups of the formula (I) —CH2-CHR—O—R¹, R is H or CH₃, and R¹ in the etherified vinyl alcohol polymers is identical or different and is unsubstituted or substituted alkyl, aryl, or alkaryl radicals each having from 1 to 30 carbon atoms, the substituents selected from the group consisting of halogen, hydroxyl, amine, ammonium, carboxylic acid, carboxylic ester, carboxamide, ether, keto, sulfonic acid, phosphonate, nitrate, and polyoxyalkylene radicals having from 2 to 50 C₂₋₈ oxyalkylene units are useful as thickeners in liquid-containing compositions, particularly hydraulically and non-hydraulically setting construction formulations such as cements, plasters, mortars, adhesives, and renders.

### BACKGROUND OF THE INVENTION

1. Field of the Invention

The invention relates to the use of etherified vinyl alcohol polymers as thickeners (rheological additives), in particular as rheological additives in construction compositions.

2. Background Art

The use of thickeners is standard in the building industry for improving the workability and water-retention properties of construction compositions such as cement mixtures, hydrated lime mixtures, and gypsum mixtures. The thickeners are water-soluble polymers whose addition inhibits loss of water from the construction compositions on highly absorbent substrates before setting, and thus avoids inadequate setting of the construction composition and cracking. Additives of this type can also be used to match the property profile of the construction compositions to a desired application profile.

The thickening additives employed are generally water-soluble polymers based on non-ionic cellulose ethers, or “derivatized cellulose” such as methylcellulose, hydroxyethylcellulose, methylhydroxyethylcellulose, and hydroxypropylcellulose. Although the amounts of these thickeners which are employed are rather small, thickeners of this type based on cellulose ethers nevertheless represent a considerable additional cost in construction compositions. There is therefore a need for rheological additives which are obtainable at lower cost.

Cellulose ethers compete as thickeners with fully synthetic polymers such as associative polyurethane thickeners, polyacrylates, polyimines, polyamides, and also with natural polymers, such as agar-agar, tragacanth, carrageenan, gum arabic, alginates, starch, gelatine, and casein. However, these alternatives are not satisfactory in construction compositions, in particular in cementitious systems which are characterized by high pH and high electrolyte content. There has not hitherto been any alternative to cellulose ethers in these applications, when workability and water-retention requirements are considered.

Etherified polyvinyl alcohols are known. DE-A 1645622 describes the preparation of polyvinyl alcohols which have been etherified with alkyl or alkenyl groups and which can be used in protective or other coatings or as textile auxiliaries. DE-A 3542368 describes polyvinyl alcohols etherified with N-methylolacrylamide and their use in offset plates. Polyvinyl alcohols etherified with alkylsulfonate groups and used as additives to increase viscosity in oil-drilling compositions have been disclosed in EP-A 99631. U.S. Pat. No. 3,386,982 describes the preparation of alkoxylated polyvinyl alcohols employing alkoxylated amines, the products being used to produce packaging films. U.S. Pat. No. 3,505,303 describes the preparation of polyvinyl alcohols modified with acrylamides via Michael addition and their use as packaging material. U.S. Pat. No. 4,744,865 discloses the use of alkylated polyvinyl alcohols for inhibiting the formation of deposits during papermaking. U.S. Pat. No. 5,783,628 discloses carboxyalkylated polyvinyl alcohols which are recommended as additives in oil-drilling compositions.

JP-A 11-157896 discloses etherified polyvinyl alcohols having carboxamide groups in the ether radical as additives for improving the mechanical strength of concrete. JP-A 11-71150 discloses etherified polyvinyl alcohols having a carboxylic acid group, carboxamide group, sulfonate group, ammonium group, or hydroxyl group in the ether radical as additives for improving the mechanical strength of concrete. Both of the foregoing specifications also recommend addition of rheological additives such as cellulose ethers or starch ethers.

### SUMMARY OF THE INVENTION

The object on which the invention was based was to provide a thickener which, in particular in construction compositions, ensures excellent workability, without exhibiting the disadvantages of prior art thickeners. Surprisingly, it has been found that thickeners based on etherified vinyl alcohol polymers give better break-out performance and open time in tensile bond strength values.

### DETAILED DESCRIPTION OF THE PREFERRED EMBODIMENT(S)

The invention provides the use of etherified vinyl alcohol polymers as thickeners. The etherified vinyl alcohol polymers are based on partially or completely hydrolyzed vinyl acetate homopolymers or on partially or completely hydrolyzed vinyl acetate copolymers, from 0.1 to 100 mol % of whose vinyl alcohol groups have been etherified, where the etherified vinyl alcohol units have the general formula (I) —CH₂—CHR—O—R¹ and R is H or CH₃, and R¹ in the etherified vinyl alcohol polymers is identical or different and is an alkyl, aryl, or alkaryl radical having from 1 to 30 carbon atoms, optionally substituted by one or more substituents from the group consisting of halogen, hydroxyl radicals, amine radicals, ammonium radicals, carboxylic acid radicals, carboxylic ester radicals, carboxamide radicals, ether radicals, keto radicals, sulfonic acid radicals, phosphonate radicals, nitrate radicals, and polyoxyalkylene radicals having from 2 to 50 C₂₋₈ oxyalkylene units.

The degree of hydrolysis of the partially hydrolyzed or completely hydrolyzed vinyl acetate homopolymers or vinyl acetate copolymers is generally from 75 to 100 mol %. In the case of completely hydrolyzed vinyl alcohol polymers the degree of hydrolysis is preferably from 97.5 to 100 mol %, more preferably from 98 to 99.5 mol %. In the case of partially hydrolyzed vinyl alcohol polymers the degree of hydrolysis is preferably from 80 to 95 mol %, more preferably from 86 to 90 mol %. The weight-average molecular weight M_{W} of the etherified vinyl alcohol polymers is ≧100,000, preferably from 100,000 to 1,000,000. The degree of etherification is from 0.1 to 100 mol %, preferably from 0.5 to 50 mol %, and most preferably from 5 to 30 mol %, in each case based on the free OH groups in the partially hydrolyzed or completely hydrolyzed vinyl acetate homopolymers or vinyl acetate copolymers.

Besides vinyl acetate units, the vinyl acetate copolymers may also contain comonomer units which are derived from one or more comonomers from the group consisting of 1-alkylvinyl C₁₋₅ carboxylic esters having a C₁₋₅-alkyl radical, allyl esters, vinyl esters of C₅₋₁₂ alpha-branched carboxylic acids, and acrylic or methacrylic esters of C₁₋₁₈ alcohols. The proportion of these comonomer units is preferably from 0.1 to 50% by weight, more preferably from 0.3 to 15% by weight, and most preferably from 0.5 to 6% by weight, based in each case on the total weight of the vinyl acetate copolymer.

A preferred 1-alkylvinyl ester is isopropenyl acetate. Preferred vinyl esters of alpha-branched carboxylic acids are those of C₉₋₁₁ alpha-branched carboxylic acids, with particular preference being given to vinyl esters of C₁₀ alpha-branched carboxylic acids (VeoVa10, trade name of Shell). Preferred acrylic or methacrylic esters are those of C₁₋₁₀ alcohols, with particular preference given to methyl acrylate, ethyl acrylate, n-butyl acrylate, tert-butyl acrylate, 2-ethylhexyl acrylate, 2-ethylhexyl methacrylate and methyl methacrylate. Where appropriate, it is also possible to copolymerize from 0.05 to 2% by weight, based on the total weight of the monomer mixture, of auxiliary monomers. Examples of auxiliary monomers are ethylenically unsaturated mono- or dicarboxylic acids, preferably acrylic acid, methacrylic acid, fumaric acid, crotonic acid, itaconic acid, and maleic acid; ethylenically unsaturated carboxamides and ethylenically unsaturated carbonitriles, preferably acrylamide or acrylonitrile; cyclic carboxamides, such as N-vinylpyrrolidone or N-vinyl-ε-caprolactam; and ethylenically unsaturated carboxylic anhydrides, preferably maleic anhydride.

Among the vinyl acetate copolymers, particular preference is given to those with from 0.3 to 15% by weight of, respectively, isopropenyl acetate, or vinyl esters of C₉₋₁₁ alpha-branched carboxylic acids, or methyl, ethyl, or butyl acrylate; those with from 0.3 to 15% by weight of isopropenyl acetate units and from 0.3 to 15% by weight of units of vinyl esters of C₉₋₁₁ alpha-branched carboxylic acids; those with from 0.5 to 6% by weight of isopropenyl acetate and from 0.5 to 6% by weight of vinyl esters of C₁₀ alpha-branched carboxylic acids (VeoVa10) and from 0.5 to 6% by weight of methyl acrylate; and also those with from 0.5 to 6% by weight of isopropenyl acetate and from 0.5 to 6% by weight of 2-ethylhexyl methacrylate and from 0.5 to 6% by weight of methyl acrylate.

Suitable radicals R in the etherified vinyl alcohol units of the general formula (I) —CH₂—CHR—O—R¹ are H and CH₃, preferably H.

Preferred radicals R¹ are unsubstituted alkyl radicals, unsubstituted aryl radicals, and unsubstituted alkaryl radicals, each having from 1 to 30 carbon atoms, more preferably methyl, ethyl, n-propyl, isopropyl, n-butyl, tert-butyl, n-pentyl, n-hexyl, 2-ethylhexyl, benzyl, dodecyl, octadecyl, pentacosyl (C₂₅), hexacosyl (C₂₆), and heptacosyl (C₂₇) radicals. Preference is also given to substituted alkyl radicals, substituted aryl radicals, and substituted alkaryl radicals, each having from 1 to 30 carbon atoms, and each having one or more substituents each from the group consisting of OH, SO₃H, NO₂, OR² where R²═C₁₋₁₈-alkyl, and NR³₂, NR³₃⁺, COOR³, COR³, and CONR³₃⁺ radicals where each R³ is identical or different and is H or a C₁₋₄-alkyl radical, and also polyoxyethylene radicals, polyoxypropylene radicals, and poly(oxyethylene)(oxypropylene) radicals each having from 2 to 50 oxyalkylene units.

The most preferred radicals R¹ are methyl, ethyl, n-propyl, n-butyl, tert-butyl, n-hexyl, 2-ethylhexyl, benzyl, dodecyl, octadecyl, hydroxymethyl, hydroxyethyl, hydroxybenzyl, CH₂CH₂SO₃H, CH₂N(CH₃)₄⁺, CH₂CH₂NH₃⁺, CH₂COOH, CHR⁴CHR⁴COOH where R⁴ is H and/or CH₃, CH₂CH₂OR² where R² is C₁₋₁₈-alkyl, preferably ethyl, propyl or octadecyl, CHR⁴CHR⁴CONR³₃⁺ where R³ is identical or different and is H and/or C₁₋₄-alkyl preferably H and/or methyl, and R⁴ is H and/or CH₃, polyoxyethylene radicals, polyoxypropylene radicals, and poly(oxyethylene)(oxypropylene) radicals, each having from 2 to 20 oxyalkylene units.

Particularly preferred etherified vinyl alcohol polymers are those of completely hydrolyzed vinyl acetate homopolymers having a degree of hydrolysis of from 97.5 to 100 mol % which have been etherified with methyl radicals or with CH₂CH₂OR² where R²═C₁-C₁₈-alkyl, preferably ethyl, propyl, or octadecyl, or with polyoxyethylene radicals or polyoxypropylene radicals each having from 2 to 20 oxyalkylene units, with CHR⁴CHR⁴COOH radicals or with CHR⁴CHR⁴CONR³₃⁺ radicals where R⁴ is H and/or CH₃ and where R³ are identical or different and are H and/or C₁₋₄-alkyl, as radical R¹, with a degree of etherification of from 5 to 30 mol %. Particular preference is also given to etherified vinyl alcohol polymers of completely hydrolyzed vinyl acetate copolymers which contain from 0.3 to 15% by weight of isopropenyl acetate units and from 0.3 to 15% by weight of units derived from vinyl esters of C₉₋₁₁ alpha-branched carboxylic acids, with a degree of hydrolysis of from 97.5 to 100 mol %, which have been etherified with, methyl radicals, or with CH₂CH₂OR² where R² is C₁₋₁₈-alkyl, preferably ethyl, propyl, or octadecyl, or with polyoxyethylene radicals or polyoxypropylene radicals each having from 2 to 20 oxyalkylene units, or with CHR⁴CHR⁴COOH radicals or with CHR⁴CHR⁴CONR³₃⁺ radicals where R⁴ is H and/or CH₃ and where R³ are identical or different and are H and/or C₁₋₄-alkyl, as radical R¹, preferably ethyl, propyl or octadecyl, with a degree of etherification of from 5 to 30 mol %.

The etherified vinyl alcohol polymers are prepared in a manner known per se, starting from the appropriate polyvinyl alcohol, by nucleophilic substitution or Michael addition of the appropriate alkylating agent. For example, an aqueous solution of the polyvinyl alcohol may be rendered alkaline, using a base at any desired concentration, preferably sodium hydroxide solution, in the presence of a water-miscible organic solvent, such as acetone or alcohol(s), e.g. isopropanol. The alkylating agent is added, and the reaction is carried out at a temperature of from 25 to 90° C., preferably from 70 to 90° C., for a period of from 1 to 10 h, preferably from 3 to 5 h. The mixture is neutralized by adding acid, preferably acetic acid, and the product is precipitated in methanol and isolated in solid form. Suitable alkylating agents are the appropriate haloalkanes, derivatives of acrylic or methacrylic acid, epoxides, and vinyl derivatives of sulfonic or phosphoric acid. The alkylating agents themselves may have been given other functionalities, for example using polyethylene oxide and/or polypropylene oxide chains, alkyl radicals, aryl radicals, or functional groups, such as ammonium groups, hydroxyl groups, ester groups, amide groups, ether groups, or acid groups.

For the etherification process it is also possible to prepare a suspension by suspending the appropriate polyvinyl alcohol in an organic solvent, preferably acetone, and to acidify this using a mineral acid, preferably hydrochloric acid. An alkylating agent, preferably the appropriate vinyl ether, is then added, and the reaction is carried out at reflux temperature for a period of from 3 to 6 h. The product is obtained by removing the solvent.

The etherified vinyl alcohol polymers may be used as thickeners in the form of an aqueous solution or in powder form, or as an additive in aqueous polymer dispersions or in water-redispersible polymer powders. They may be used alone or mixed with other rheology additives. The amount of the thickener generally used is from 0.01 to 20% by weight of thickener (solid), based on the total weight of the formulation to be thickened. The etherified vinyl alcohol polymers are suitable for use as thickeners in all of the fields where rheological auxiliaries are used, for example as thickeners in cosmetics, in the pharmaceutical sector, in water-based silicone emulsions, in silicone oils, in formulations for coating compositions, such as emulsion paints or textile coatings, or as thickeners in adhesive formulations, or as thickeners in construction applications, or else in hydraulically setting or non-hydraulically-setting formulations, such as concrete, cement mortar, lime mortar, or gypsum mortar. There are also possible applications in water-containing mixes where cellulose ethers and starch ethers are also used as thickeners.

Particular preference is given to construction applications, with especial preference given to cementitious construction applications such as cementitious construction adhesives (tile adhesives), cementitious dry mortars, flowable cementitious compositions, cementitious non-shrink grouts, cementitious renders, or cementitious exterior insulation system adhesives.

Typical mixes for cementitious construction applications comprise from 5 to 80% by weight of cement, from 5 to 80% by weight of fillers such as quartz sand, calcium carbonate, or talc, from 0.5 to 60% by weight of polymer dispersion or polymer powder, and also from 0.1 to 5% by weight of thickener, and, where appropriate, other additives for improving stability, workability, open time, and water resistance. The % by weight data given here are always based on 100% by weight of dry composition for the mix and their total is 100% by weight. The cement-containing mixes mentioned are mainly used in applying tiles of all types (earthenware, stoneware, porcelain, ceramics, natural tiles), indoors or outdoors, and are mixed with the appropriate amount of water prior to use.

The thickeners of the invention are also suitable for use in cement-free construction mixes, for example with the appropriate amount of gypsum or water glass as inorganic binder, and preferably in gypsum-containing compositions, such as gypsum renders or gypsum trowelling compounds. The cement-free mixes are used especially in trowelling compounds, tile adhesives, exterior insulation system adhesives, renders, or paints. Typical mixes for gypsum formulations comprise from 15 to 96% by weight of calcium sulfate, from 3 to 80% by weight of fillers such as quartz sand, calcium carbonate, or talc, from 0 to 5% by weight of hydrated lime, from 0 to 5% by weight of polymer dispersion or polymer powder, and also from 0.01 to 3% by weight of thickener, and, where appropriate, other additives for improving stability, workability, open time, and water resistance. The data given in % by weight are always based on 100% by weight of dry material of the mix, and give a total of 100% by weight.

The etherified polyvinyl alcohols are rheological additives which give excellent workability in cementitious construction compositions such as tile adhesives. Only partial replacement of cellulose ethers, for example by starch thickeners or water-soluble polacrylates has hitherto been possible in cementitious construction formulations, and then with considerable sacrifice of technical quality of the construction composition. Until now, polyvinyl alcohols have only been used in small amounts, as auxiliary additives. Using the etherified polyvinyl alcohols it is possible to replace cellulose ethers in cementitious applications without loss of quality. The cement setting performance obtained is better than with methylhydroxyethylcelluloses.

### EXAMPLE 1

4350 g of a 6.5% strength aqueous solution of polyvinyl alcohol with a degree of hydrolysis 99.5%, molecular weight >100,000 were charged to a pressure vessel of 15 liter capacity. After inertization by evacuation and nitrogen flushing, 250 g of acetone and 565 g of 46% strength sodium hydroxide solution were added. The reaction with alkali then proceeded at 25° C. for 60 minutes, and 325 g of methyl chloride were then added. The reaction mixture was heated to 80° C. and held at this temperature for 4 hours. Cooling to room temperature was followed by neutralization with acetic acid. The reaction solution was added dropwise to an excess of methanol, whereupon the vinyl alcohol polymer precipitated. The product was isolated by suction filtration and dried at 50° C., yielding a polyvinyl alcohol partially etherified with methyl groups with a degree of etherification about 10 mol %, capable of being used as a solution or in powder form.

### EXAMPLE 2

Example 1 was repeated, but 150 g of ethylene oxide were used instead of methyl chloride, yielding a polyvinyl alcohol partially etherified with oxyethylene groups.

### EXAMPLE 3

835 g of a 6.5% strength aqueous solution of polyvinyl alcohol with a degree of hydrolysis 99.5%, molecular weight >100,000 were charged to a laboratory apparatus of 3 liter capacity. After inertization by evacuation and nitrogen flushing, 45 g of acetone and 6 g of 46% strength sodium hydroxide solution were added. The reaction with alkali then proceeded at 25° C. for 60 minutes, and 5.5 g of 1,2-epoxybutane were then added. The reaction mixture was heated to 60° C. and held at this temperature for 4 hours. Cooling to room temperature was followed by neutralization with acetic acid. The reaction solution was added dropwise to an excess of methanol, whereupon the vinyl alcohol polymer precipitated. The product was isolated by suction filtration and dried at 50° C., yielding a polyvinyl alcohol partially etherified with butyl groups with a degree of etherification about 5 mol %, capable of being used as a solution or in powder form.

### EXAMPLE 4

835 g of a 6.5% strength aqueous solution of polyvinyl alcohol with a degree of hydrolysis 99.5%, molecular weight >100,000 are charged to a laboratory apparatus of 3 liter capacity. After inertization by evacuation and nitrogen flushing, 45 g of acetone and 12 g of 46% strength sodium hydroxide solution were added. The reaction with alkali then proceeded at 25° C. for 60 minutes, and 40 g of 1-bromohexane were then added. The reaction mixture was heated to 80° C. and held at this temperature for 4 hours. Cooling to room temperature was followed by neutralization with acetic acid. The reaction solution was added dropwise to an excess of methanol, whereupon the vinyl alcohol polymer precipitated. The product was isolated by suction filtration and dried at 50° C., yielding a polyvinyl alcohol partially etherified with hexyl groups with a degree of etherification about 5 mol %, capable of being used as a solution or in powder form.

### EXAMPLE 5

40 g of polyvinyl alcohol with a degree of hydrolysis 99.5%, molecular weight >100,000 were suspended in 435 g of acetone in a laboratory apparatus of 3 liter capacity. After inertization by evacuating and flushing with nitrogen, 2 g of 37% strength hydrochloric acid and 14 g of ethyl vinyl ether were added. The reaction mixture was heated to reflux temperature and held at this temperature for 5 h. Cooling to room temperature was followed by removal of the volatile fractions, and the product was then dried at 50° C., yielding a polyvinyl alcohol partially etherified with ethyloxyethyl radicals with a degree of etherification about 15 mol %, capable of use as a solution or in powder form.

### EXAMPLE 6

Example 1 was repeated, but use was made of a completely hydrolyzed copolymer of vinyl acetate, vinyl esters of C₁₀ alpha-branched carboxylic acids (VeoVa10), and isopropenyl acetate, with a degree of hydrolysis of about 99%.

### EXAMPLE 7

Example 2 was repeated, but use was made of a completely hydrolyzed copolymer of vinyl acetate, vinyl esters of C₁₀ alpha-branched carboxylic acids (VeoVa10), and isopropenyl acetate, with a degree of hydrolysis of about 99%.

### EXAMPLE 8

Example 3 was repeated, but use was made of a completely hydrolyzed copolymer of vinyl acetate, vinyl esters of C₁₀ alpha-branched carboxylic acids (VeoVa10), and isopropenyl acetate, with a degree of hydrolysis of about 99%.

### EXAMPLE 9

Example 4 was repeated, but use was made of a completely hydrolyzed copolymer of vinyl acetate, vinyl esters of C₁₀ alpha-branched carboxylic acids (VeoVa10), and isopropenyl acetate, with a degree of hydrolysis of about 99%.

### EXAMPLE 10

Example 5 was repeated, but use was made of a completely hydrolyzed copolymer of vinyl acetate, vinyl esters of C₁₀ alpha-branched carboxylic acids (VeoVa10), and isopropenyl acetate, with a degree of hydrolysis of about 99%.

### EXAMPLE 11

1750 g of a 5% strength aqueous solution of a completely hydrolyzed copolymer of vinyl acetate, vinyl esters of C₁₀ alpha-branched carboxylic acids (VeoVa10), and isopropenyl acetate, were charged to a laboratory apparatus of 3 liter capacity. Inertization by evacuating and flushing with nitrogen was followed by addition of 17.5 g of 10% strength sodium hydroxide solution, and the temperature was increased to 30° C. 35 g of 25% strength vinylsulfonate solution were then added. The reaction mixture was held at 30° C. for 5 h. Cooling to room temperature was followed by neutralization with acetic acid, and the volume of the reaction solution was reduced to one third of its initial volume. The reaction solution was added dropwise to an excess of a mixture of acetone and methanol (4:1), whereupon the etherified vinyl alcohol polymer precipitated. The product was isolated by suction filtration and dried at 50° C., yielding a polyvinyl alcohol partially etherified with ethylsulfonic acid radicals with a degree of etherification about 3 mol %, capable of use as a solution or in powder form.

### EXAMPLE 12

Example 11 was repeated, but 30 g of a 30% strength acrylamide solution were used instead of vinylsulfonate, yielding a polyvinyl alcohol partially etherified with CH₂CH₂CONH₂ radicals with a degree of etherification about 5 mol %, capable of use as a solution or in powder form.

### COMPARATIVE EXAMPLE 13

A commercially available hydroxyethylmethylcellulose with a Höppler viscosity of 6000 mPas (DIN 53015, 2% by weight aqueous solution).

### COMPARATIVE EXAMPLE 14

A commercially available, completely hydrolyzed polyvinyl alcohol with a degree of hydrolysis of 99.5 mol % and a molecular weight >100,000.

Testing of Thickeners:

The following formulation was used to test the thickeners:

55.2 parts by weight of quartz sand No. 9a (0.1-0.4 mm),

43.0 parts by weight of cement 42.5 (Rohrdorfer),

1.5 parts by weight of redispersion powder (Vinnapas RE 530 Z),

0.7 part by weight of thickener.

The dry mixtures were treated with the amounts of water indicated in Table 1, and the mixture was allowed to stand for 5 minutes before it was tested.

Test Methods:

Determination of Trowel Adhesion:

The trowel adhesion of the mixture was determined qualitatively by visual assessment. Results were evaluated on a grading scale from 1 to 6, grade 1 being the best.

Determination of Plasticity:

The plasticity of the mixture was determined qualitatively by visual assessment. Results were evaluated on a grading scale from 1 to 6, grade 1 being the best.

Determination of Wetting Properties:

The wetting of a tile was determined qualitatively by visual assessment during application of the mortar. Results were evaluated on a grading scale from 1 to 6, grade 1 being the best.

Determination of Quality of Bead Production:

The quality of bead production was determined qualitatively by visual assessment. Results were evaluated on a grading scale from 1 to 6, grade 1 being the best.

Post-thickening:

The post-thickening of the mixture was determined qualitatively by visual assessment. The results were evaluated on a grading scale from 1 to 6, grade 1 being the best.

Determination of Water Retention:

Water retention was tested in accordance with DIN 18555 Part 7.

Determination of break-out:

To determine break-out, a tile (5×5 cm) was placed into the mortar after 10 minutes and break-out was determined after 60 minutes by evaluating the wetting of the reverse side of the tile with mortar.

Determination of Stability (Slip Test):

For the slip test, a tile (15×15 cm) was placed, as above, into the tile adhesive formulation, and the test rig was set in a vertical position. The upper edge of the tile was then loaded with weights, each time for 30 seconds, and the weight at which the tile slips was recorded.

Determination of Open Time:

Open time was tested in accordance with EN 1348.

Determination of Cement-setting Performance:

Cement-setting performance was determined for a mixture made from cement, water, and thickener polymer (water/cement 0.4; polymer/cement 0.0075) using a heat sensor. The test cement utilized was Rohrdorf 42.5 R. The maximum temperature for the setting process was determined and the delay (values>100) or the acceleration of the setting process (values<100) was determined relative to the polymer-free mixture.

Discussion of Test Results:

The test results presented in Table 1 show that the thickeners based on etherified vinyl alcohol polymers (examples 1 to 12) give markedly better workability (trowel adhesion, plasticity, post-thickening) than conventional polyvinyl alcohol (comparative example 14), and substantially better thickening action (break-out, water retention). In comparison with conventional thickeners based on cellulose ethers (comparative example 13), the etherified vinyl alcohol copolymers have markedly better workability (plasticity, wetting, bead production) and markedly accelerated setting performance (cement setting).

TABLE 1

| | | | | | | | | | | | | | C. Ex. | C. Ex. |
|---|---|---|---|---|---|---|---|---|---|---|---|---|---|---|
| Additive | Ex. 1 | Ex. 2 | Ex. 3 | Ex. 4 | Ex. 5 | Ex. 6 | Ex. 7 | Ex. 8 | Ex. 9 | Ex. 10 | Ex. 11 | Ex. 12 | 13 | 14 |
| Amount of | 22.4 | 22.8 | 22.7 | 22.3 | 22.3 | 22.4 | 23.1 | 22.9 | 22.5 | 23 | 23.5 | 23.7 | 23 | 21.9 |
| water [g] | | | | | | | | | | | | | | |
| Trowel | 2 | 1.5 | 1.5 | 2 | 1.5 | 2 | 1.5 | 1 | 1.5 | 1 | 1.5 | 1.5 | 2 | 3 |
| adhesion | | | | | | | | | | | | | | |
| Plasti-city | 2 | 1.5 | 2 | 1.5 | 2 | 1 | 1 | 1 | 1 | 1.5 | 1.5 | 1.5 | 2.5 | 3.5 |
| Wetting | 2.5 | 2 | 1.5 | 1.5 | 2 | 1.5 | 1 | 1 | 1 | 1.5 | 2 | 1.5 | 2.5 | 4.5 |
| Bead | 2.5 | 2 | 2 | 2 | 2 | 1.5 | 1.5 | 1.5 | 1.5 | 1 | 1 | 1 | 2.5 | 5 |
| production | | | | | | | | | | | | | | |
| Post- | 1.5 | 1.5 | 2 | 1 | 1.5 | 1.5 | 1 | 1 | 1 | 1.5 | 2 | 2 | 2 | 2 |
| thickening | | | | | | | | | | | | | | |
| Breakout 10′ | 86 | 91 | 89 | 89 | 91 | 91 | 96 | 95 | 92 | 97 | 96 | 94 | 96 | 45 |
| [%] | | | | | | | | | | | | | | |
| Open time 0′ | 1.85 | 1.84 | 1.86 | 1.84 | 1.81 | 1.89 | 1.99 | 1.9 | 1.91 | 1.94 | 1.94 | 1.92 | 1.91 | 1.74 |
| Open time 10′ | 1.15 | 1.2 | 1.28 | 1.09 | 1.09 | 1.23 | 1.41 | 1.34 | 1.15 | 1.32 | 1.13 | 1.1 | 0.8 | 0.81 |
| Open time 20′ | 0.42 | 0.53 | 0.64 | 0.51 | 0.54 | 0.57 | 0.88 | 0.78 | 0.68 | 0.67 | 0.54 | 0.58 | 0.31 | 0.25 |
| Water | 98 | 98.2 | 98.1 | 97.8 | 98.1 | 98.1 | 98.4 | 98.6 | 98 | 98.1 | 98.6 | 98.5 | 98.5 | 96.5 |
| retention [%] | | | | | | | | | | | | | | |
| Slip test [g] | 200 | 200 | 200 | 200 | 200 | 200 | 200 | 200 | 200 | 200 | 400 | 400 | 200 | 400 |
| Cement | 101 | 109 | 107 | 98 | 100 | 104 | 112 | 107 | 100 | 104 | 114 | 118 | 185 | 120 |
| Setting | | | | | | | | | | | | | | |
| performance | | | | | | | | | | | | | | |
| [%] | | | | | | | | | | | | | | |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A process for thickening a liquid-containing composition, said process comprising adding to said liquid-containing composition one or more etherified vinyl alcohol polymers comprising partially or completely hydrolyzed vinyl acetate homopolymers or partially or completely hydrolyzed vinyl acetate copolymers, from 0.1 to 100 mol % of whose vinyl alcohol groups have been etherified, wherein the etherified vinyl alcohol groups have the formula (I) —CH2-CHR—O—R¹ and R is H or CH₃, and R¹ in the etherified vinyl alcohol polymers are identical or different and are optionally substituted alkyl, aryl, or alkaryl radicals each having from 1 to 30 carbon atoms, wherein the substituted alkyl, aryl, or alkaryl radicals bear one or more substituents selected from the group consisting of halogen, hydroxyl radicals, amine radicals, ammonium radicals, carboxylic acid radicals, carboxylic ester radicals, carboxamide radicals, ether radicals, keto radicals, sulfonic acid radicals, phosphonate radicals, nitrate radicals, and polyoxyalkylene radicals having from 2 to 50 C₂₋₈ oxyalkylene units.

2. The process of claim 1, wherein said etherified vinyl alcohol polymers comprise etherified vinyl acetate homopolymers or vinyl acetate copolymers having a degree of hydrolysis of from 75 to 100 mol %.

3. The process of claim 1, wherein said etherified vinyl alcohol polymers comprise completely hydrolyzed vinyl acetate homopolymers, or completely hydrolyzed vinyl acetate copolymers having comonomer units derived from one or more comonomers from the group consisting of 1-alkylvinyl C₁₋₅ carboxylic esters having a C₁₋₅-alkyl radical, allyl esters, vinyl esters of C₅₋₁₂ alpha-branched carboxylic acids, acrylic or methacrylic esters of C₁₋₁₈ alcohols, said completely hydrolyzed vinyl acetate homopolymers or completely hydrolyzed vinyl acetate copolymers having a degree of hydrolysis of from 97.5 to 100 mol %, and said etherified completely hydrolyzed vinyl acetate homopolymers or said etherified completely hydrolyzed vinyl acetate having a degree of etherification of from 0.5 to 50 mol %, based on the free OH groups of the completely hydrolyzed vinyl acetate homopolymers or vinyl acetate copolymers.

4. The process of claim 1, wherein the radicals R¹ are identical and are unsubstituted alkyl, aryl, or alkaryl radicals selected from the group consisting of methyl, ethyl, n-propyl, isopropyl, n-butyl, tert-butyl, n-pentyl, n-hexyl, 2-ethylhexyl, benzyl, dodecyl, octadecyl, pentacosyl (C₂₅), hexacosyl (C₂₆), and heptacosyl (C₂₇) radicals.

5. The process of claim 1, wherein the radicals R¹ are identical and are substituted alkyl, aryl, or alkaryl radicals each having from 1 to 30 carbon atoms bearing a substituent selected from the group consisting of the OH, SO₃H, NO₂, OR² where R² is C₁₋₁₈-alkyl, NR³₂, NR³₃⁺, COOR³, COR³, CONR³₃⁺ where each R³ is identical or different and is H or a C₁₋₄-alkyl radical, polyoxyethylene, polyoxypropylene, and poly(oxyethylene)(oxypropylene) each polyoxyethylene, polyoxypropylene, and poly(oxyethylene)(oxypropylene) having from 2 to 50 oxyalkylene units.

6. The process of claim 1, wherein the radicals R¹ are identical and are a radical selected from the group consisting of methyl, ethyl, n-propyl, n-butyl, tert-butyl, n-hexyl, 2-ethylhexyl, benzyl, dodecyl, octadecyl, hydroxymethyl, hydroxyethyl, hydroxybenzyl, CH₂CH₂SO₃H, CH₂N(CH₃)₄⁺, CH₂CH₂NH₃⁺, CH₂COOH, CHR⁴CHR⁴COOH where R⁴=H and/or CH₃, CH₂CH₂OR² where R²=C₁₋₁₈-alkyl, CHR⁴CHR⁴CONR³₃⁺ where R³ is identical or different and is H and/or C₁₋₄-alkyl and R⁴ is H and/or CH₃, polyoxyethylene, polyoxypropylene, and the poly(oxyethylene)(oxypropylene), each polyoxyethylene, polyoxypropylene, and poly(oxyethylene)(oxypropylene) having from 2 to 20 oxyalkylene units.

7. The process of claim 1, wherein said etherified vinyl alcohol polymers comprise completely hydrolyzed vinyl acetate homopolymers having a degree of hydrolysis of from 97.5 to 100 mol % and a degree of etherification of from 5 to 30 mol %, which have been etherified with methyl radicals as radical R¹ or with polyoxyethylene or polyoxypropylene radicals having from 2 to 20 oxyalkylene units; or which comprise etherified vinyl alcohol polymers of completely hydrolyzed vinyl acetate copolymers which contain from 0.3 to 15% by weight of isopropenyl acetate units and from 0.3 to 15% by weight of units derived from vinyl esters of C₉₋₁₁ alpha-branched carboxylic acids, with a degree of hydrolysis of from 97.5 to 100 mol % and a degree of etherification of from 5 to 30 mol %, which have been etherified, as radical R¹, with methyl radicals, CH₂CH₂OR² where R²═C₁₋₁₈-alkyl, or with a polyoxyethylene radical or polyoxypropylene radical each polyoxyethylene or polyoxypropylene having from 2 to 20 oxyalkylene units; or mixtures of said etherified completely hydroyzed vinyl acetate homopolymers and etherified completely hydrolyzed vinyl acetate copolymers.

8. The process of claim 1, wherein the thickeners are used in the form of an aqueous solution or in powder form, or as an additive in aqueous polymer dispersions or in water-redispersible polymer powders, in amounts of from 0.01 to 20% by weight of thickener (solid), based on the total weight of the formulation to be thickened, and wherein said formulation to be thickened comprises a cosmetic formulation, a pharmaceutical formulation, a water-based silicone emulsion, a silicone oil, a coating composition formulation, an adhesive formulation, or a construction formulation.

9. The process of claim 8, wherein said formulation is a construction formulation comprising a hydraulically setting or non-hydraulically-setting formulation.

10. The process of claim 9 which comprises a cementious construction adhesive, a cementious dry mortar, a flowable cementious composition, a cementious non-shrink grout, a cementious render, or a cementious exterior insulation system adhesive.

11. The process of claim 9, wherein said formulation comprises a cement-free trowelling compound, render, tile adhesive, or exterior insulation system adhesive.

12. The process of claim 11 wherein said formulation comprises a gypsum-containing formulation.

13. The process of claim 12, wherein said formulation comprises a gypsum renders or gypsum trowelling compound.

14. The process of claim 9, wherein said formulation further comprises one or more water-redispersible redispersion powders.

15. In a process for thickening an aqueous construction composition wherein a cellulose derivative is ordinarily employed as a thickener, the improvement comprising substituting for at least a portion of said cellulose derivative thickener, an etherified polyvinyl alcohol homopolymer, etherified polyvinyl alcohol copolymer, or mixture thereof, wherein said etherified polyvinyl alcohol homopolymer, etherified polyvinyl alcohol copolymer, or mixture thereof contain etherified vinyl alcohol groups having the formula (I) —CH2-CHR—O—R¹ and R is H or CH₃, and R¹ in the etherified vinyl alcohol polymers are identical or different and are optionally substituted alkyl, aryl, or alkaryl radicals each having from 1 to 30 carbon atoms, wherein the substituted alkyl, aryl, or alkaryl radicals bear one or more substituents selected from the group consisting of halogen, hydroxyl radicals, amine radicals, ammonium radicals, carboxylic acid radicals, carboxylic ester radicals, carboxamide radicals, ether radicals, keto radicals, sulfonic acid radicals, phosphonate radicals, nitrate radicals, and polyoxyalkylene radicals having from 2 to 50 C₂₋₈ oxyalkylene units.

16. The process of claim 15 wherein said aqueous construction composition is a hydraulically setting cementious composition.

17. The process of claim 15 wherein said aqueous construction composition is a settable composition comprising gypsum, lime, water glass, or a mixture thereof as a binder.

18. A settable construction composition comprising cement, gypsum, lime, water glass, or a mixture thereof, and further comprising one or more etherified vinyl alcohol polymers comprising partially or completely hydrolyzed vinyl acetate homopolymers or partially or completely hydrolyzed vinyl acetate copolymers, from 0.1 to 100 mol % of whose vinyl alcohol groups have been etherified, wherein the etherified vinyl alcohol groups have the formula (I) —CH2—CHR—O—R¹ and R is H or CH₃, and R¹ in the etherified vinyl alcohol polymers are identical or different and are optionally substituted alkyl, aryl, or alkaryl radicals each having from 1 to 30 carbon atoms, wherein the substituted alkyl, aryl, or alkaryl radicals bear one or more substituents selected from the group consisting of halogen, hydroxyl radicals, amine radicals, ammonium radicals, carboxylic acid radicals, carboxylic ester radicals, carboxamide radicals, ether radicals, keto radicals, sulfonic acid radicals, phosphonate radicals, nitrate radicals, and polyoxyalkylene radicals having from 2 to 50 C₂₋₈ oxyalkylene units.

19. The settable construction composition of claim 18, wherein the radicals R¹ are identical and are unsubstituted alkyl, aryl, or alkaryl radicals selected from the group consisting of methyl, ethyl, n-propyl, isopropyl, n-butyl, tert-butyl, n-pentyl, n-hexyl, 2-ethylhexyl, benzyl, dodecyl, octadecyl, pentacosyl (C₂₅), hexacosyl (C₂₆), and heptacosyl (C₂₇) radicals.

20. The settable construction composition of claim 18 which is a composition selected from the group consisting of concrete, cement mortar, lime mortar, gypsum mortar, cementious non-shrink grout, cementious render, cementious exterior insulation system adhesive, gypsum render, gypsum troweling compound, and tile adhesive.
